(19) United States
(12) Patent Application Publication
(10) Pub. No.: US 2025/0305961 A1
(43) Pub. Date: Oct. 2, 2025

(54) PHYSICAL PROPERTY VALUE CALCULATION METHOD FOR POLYMER MATERIAL, PHYSICAL PROPERTY VALUE CALCULATION DEVICE FOR POLYMER MATERIAL, AND INFORMATION STORAGE MEDIUM

(71) Applicant: Otsuka Electronics Co., Ltd., Osaka (JP)

(72) Inventors: Yoshi ENAMI, Osaka (JP); Motonobu AKAGI, Osaka (JP); Kazuhiro SUGITA, Osaka (JP)

(21) Appl. No.: 19/087,617

(22) Filed: Mar. 24, 2025

(30) Foreign Application Priority Data
Mar. 26, 2024 (JP) 2024-049948

(51) Int. Cl. G01N 21/65

(52) U.S. Cl. CPC G01N 21/65; G01N 2201/1293

(57) ABSTRACT

A physical property value calculation device includes at least one processor configured to: separate a superimposed peak into an estimated main peak corresponding to a main peak and an estimated sub-peak corresponding to a sub-peak, by applying a predetermined fitting function to each of the main peak and the sub-peak; calculate a main intensity index value indicating an intensity of the estimated main peak and a sub-intensity index value indicating an intensity of the estimated sub-peak; and calculate a physical property value of the polymer material based on the main intensity index value and the sub-intensity index value.

### CROSS-REFERENCE TO RELATED APPLICATIONS

The present application claims priority from Japanese Application JP2024-049948 filed on Mar. 26, 2024, the content of which is hereby incorporated by reference into this application.

### BACKGROUND OF THE INVENTION

### 1. Field of the Invention

The present invention relates to a physical property value calculation method for a polymer material, a physical property value calculation device for a polymer material, and an information storage medium.

### 2. Description of the Related Art

Hitherto, there has been known a method of measuring a Raman spectrum of a polymer material and calculating physical property values of the polymer material based on a peak area of the Raman spectrum. For example, in Japanese Patent No. 4384571, there is disclosed a method of: measuring a Raman spectrum of a polymer material such as polyethylene; calculating, of peaks of the Raman spectrum, each of an area of a peak (hereinafter sometimes referred to as “P1”) derived from crystalline CH₂ twisting vibration, an area of a peak (hereinafter sometimes referred to as “P2”) positioned on a higher wavenumber side than P1 and derived from amorphous CH₂ twisting vibration, and an area of a peak (hereinafter sometimes referred to as “P4”) derived from crystalline CH₂ bending vibration; and calculating, by Equation (1) below, a degree of crystallinity of the polymer material to be measured.

$$α = \frac{{I}_{P 4}}{0.46 ( {I}_{P 1} + {I}_{P 2} )} \qquad ( 1 )$$

In Equation (1) above, ∝ represents the degree of crystallinity of the polymer material to be measured, I P1 represents the area of P1, Iₚ₂ represents the area of P2, and I_{P4} represents the area of P4.

### SUMMARY OF THE INVENTION

However, in the above-mentioned related art, when a slope appears in a baseline of the Raman spectrum, it is difficult to calculate accurate physical property values. The baseline of the Raman spectrum may have a slope ascribable to fluorescence, ambient light, or the like. According to an investigation conducted by the inventors of the present application (hereinafter sometimes referred to simply as “the inventors”), it has been found that, in the above-mentioned related art, P4 particularly among the peaks used for calculating physical property values is liable to be influenced by such a slope of the baseline. In the above-mentioned related art, the physical property values of the polymer material to be measured are calculated based on the peak area of P4, but when a slope appears in the baseline, errors are liable to occur in the calculated values of the peak area of P4, and hence it is difficult to calculate accurate physical property values.

One aspect of the present invention has been made in view of the above-mentioned problem, and one object thereof is to provide a physical property value calculation method for a polymer material, a physical property value calculation device for a polymer material, and an information storage medium, which enable easy calculation of accurate physical property values even when a slope appears in the baseline.

A physical property value calculation method for a polymer material according to one embodiment of the present invention includes: a spectrum acquisition step of acquiring a Raman spectrum of a polymer material, the Raman spectrum having a superimposed peak in which a main peak and a sub-peak overlap, wherein the main peak is derived from crystalline CH₂ twisting vibration, and the sub-peak includes a first component positioned at a higher wavenumber side than the main peak and derived from amorphous CH₂ twisting vibration, and a second component positioned at a lower wavenumber side than the main peak; a peak separation step of separating the superimposed peak into an estimated main peak corresponding to the main peak and an estimated sub-peak corresponding to the sub-peak, by applying a predetermined fitting function to each of the main peak and the sub-peak; a peak intensity index value calculation step of calculating a main intensity index value indicating an intensity of the estimated main peak and a sub-intensity index value indicating an intensity of the estimated sub-peak; and a physical property value calculation step of calculating a physical property value of the polymer material based on the main intensity index value and the sub-intensity index value.

According to one aspect of the present invention, it is possible to easily calculate accurate physical property values even when a slope occurs in the baseline.

### BRIEF DESCRIPTION OF THE DRAWINGS

FIG. 1 is a graph for showing an example of a Raman spectrum of polyethylene.

FIG. 2 is a graph for showing a slope of a baseline of the Raman spectrum.

FIG. 3 is a graph for showing an example of peak fitting in a first embodiment of the present invention.

FIG. 4 is a diagram for illustrating an example of an overall configuration of a Raman microscope in the first embodiment.

FIG. 5 is a functional block diagram for illustrating an example of functions implemented by a physical property value calculation device according to the first embodiment.

FIG. 6 is a flow chart for illustrating an example of processing executed in the physical property value calculation device according to the first embodiment.

FIG. 7 is a graph for showing an example of peak fitting in a second embodiment of the present invention.

FIG. 8 is a flow chart for illustrating an example of processing executed in the physical property value calculation device according to the second embodiment.

### DETAILED DESCRIPTION OF THE INVENTION

### 1. First Embodiment

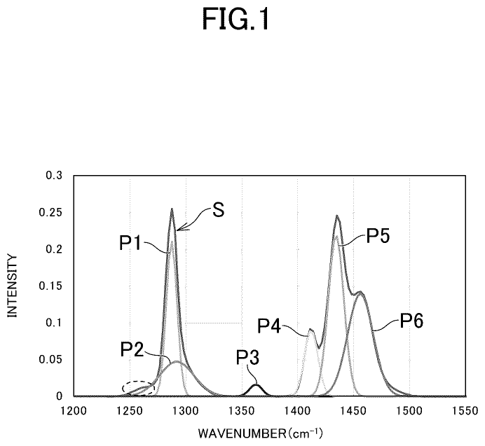

A first embodiment of the present invention is described below with reference to FIG. 1 to FIG. 6.

### 1-1. Overview of First Embodiment

FIG. 1 is a graph for showing an example of a Raman spectrum of polyethylene. As described above, in Japanese Patent No. 4384571, there is disclosed a method of: measuring a Raman spectrum of polyethylene; calculating, of peaks of a Raman spectrum S shown in FIG. 1, each of an area of a peak P1 derived from crystalline CH₂ twisting vibration, an area of a peak P2 derived from amorphous CH₂ twisting vibration, and an area of a peak P4 derived from crystalline CH₂ bending vibration; and calculating, by Equation (1), a degree of crystallinity of the polyethylene to be measured. In Japanese Patent No. 4384571, there is also disclosed a method of calculating an oxidation level of the polyethylene based on the calculated degree of crystallinity through use of a calibration curve indicating a relationship between the degree of crystallinity and the oxidation level.

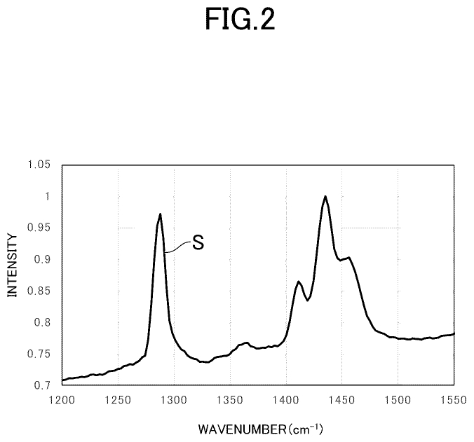

However, when a slope appears in the baseline of the Raman spectrum S, it is difficult to calculate an accurate degree of crystallinity and oxidation level. As shown in FIG. 2, the baseline of the Raman spectrum S may have a slope ascribable to fluorescence, ambient light, or the like. FIG. 2 is a graph for showing a slope of the baseline of the Raman spectrum S. According to an investigation conducted by the inventors, it has been found that, in the method of Japanese Patent No. 4384571, P4 particularly among the peaks used for calculating a degree of crystallinity is liable to be influenced by such a slope of the baseline. In the method of Japanese Patent No. 4384571, the degree of crystallinity and the oxidation level of the polyethylene to be measured are calculated based on a peak area of P4, but when a slope appears in the baseline, errors are liable to occur in the calculated values of the peak area of P4, and hence it is difficult to calculate an accurate degree of crystallinity and oxidation level.

In order to solve the above-mentioned problem, the inventors have investigated calculation of the degree of crystallinity and the oxidation level based only on P1 and P2 without use of P4.

In the course of the investigation, the inventors discovered that there is another peak (hereinafter sometimes referred to as “P7”) on a lower wavenumber side than P1 and P2 as shown in a portion surrounded by the broken line in FIG. 1. The inventors conceived that, in further consideration of this P7 in addition to P1 and P2, it is possible to accurately calculate the degree of crystallinity and the oxidation level even without using P4.

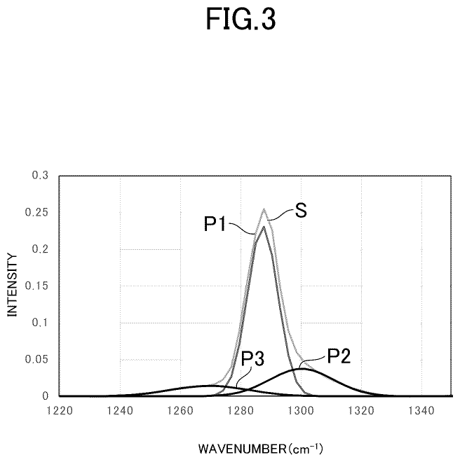

In view of this, in the first embodiment, as shown in FIG. 3, a superimposed peak, in which a plurality of peaks overlap, and which appears in a region of from 1,220 cm⁻¹ to 1, 340 cm⁻¹ in the Raman spectrum S of the polyethylene to be measured, is separated into three peaks P1, P2, and P7. The peak separation is performed by applying a predetermined fitting function to each peak (peak fitting). FIG. 3 is a graph for showing an example of the peak fitting in the first embodiment. Then, an area of each of P1, P2, and P7 described above is calculated, and the degree of crystallinity and oxidation level of the polyethylene to be measured are calculated based on the area of P1, the area of P2, and the area of P7.

In this manner, in the first embodiment, the degree of crystallinity and the oxidation level are calculated based on the area of P1, the area of P2, and the area of P7 that are relatively less liable to be influenced by the slope of the baseline. That is, in the first embodiment, when the degree of crystallinity and the oxidation level are to be calculated, it is not required to use P4 that is liable to be influenced by the slope of the baseline. Thus, according to the first embodiment, even when a slope appears in the baseline, it is possible to easily calculate an accurate degree of crystallinity and oxidation level.

In addition, while spectral sensitivity characteristics of Raman spectroscopic measurement devices differ among models of the measuring devices, according to the investigation conducted by the inventors, it has been found that P4 is liable to be influenced by the difference in the spectral sensitivity characteristics among the models. For that reason, in the related art, there occurs a problem in that, even with the same sample being used, when different models are used to measure the sample, the calculated degree of crystallinity and oxidation level may vary. In contrast, according to the first embodiment, it is not required to use P4, and hence it is possible to suppress the variation in the calculated degree of crystallinity and oxidation level among different models.

Further, while chromatic aberration may occur when light passes through a lens such as an objective lens particularly in measurement using a Raman microscope, according to the investigation conducted by the inventors, it has been found that P4 is liable to be influenced by such chromatic aberration. For that reason, in the related art, errors are liable to occur when the degree of crystallinity and the oxidation level are calculated based on a Raman spectrum obtained by the measurement using a Raman microscope. In contrast, according to the first embodiment, it is not required to use P4, and hence errors are less liable to occur even when the degree of crystallinity and the oxidation level are calculated based on a Raman spectrum obtained by the measurement using a Raman microscope.

Details of the first embodiment are described below.

In the first embodiment, a case in which the polymer material is polyethylene, in particular, polyethylene that is used as a material for an artificial joint is described as an example. Hitherto, quality control of the artificial joint has been performed through measurement of the oxidation level of polyethylene contained in the artificial joint (Reference Document 1: ISO 5934-4 Implants for surgery-Ultra-high-molecular-weight polyethylene-Part 4: Oxidation index measurement method).

In this case, one of the objects of Japanese Patent No. 4384571 is to accurately calculate the oxidation level of polyethylene contained in an artificial joint in a non destructive manner. Some artificial joints have vitamin E added as an antioxidant, but vitamin E emits fluorescence, and hence it is difficult to accurately calculate the oxidation level of polyethylene contained in such an artificial joint through use of the method of Japanese Patent No. 4384571. According to the first embodiment, even when a slope appears in the baseline due to the fluorescence of vitamin E contained in the artificial joint, the oxidation level of the polyethylene contained in the artificial joint can be accurately calculated, and hence the quality control of the artificial joint can be carried out more accurately than in the case of the method of Japanese Patent No. 4384571.

### 1-2. Overall Configuration of Raman Microscope

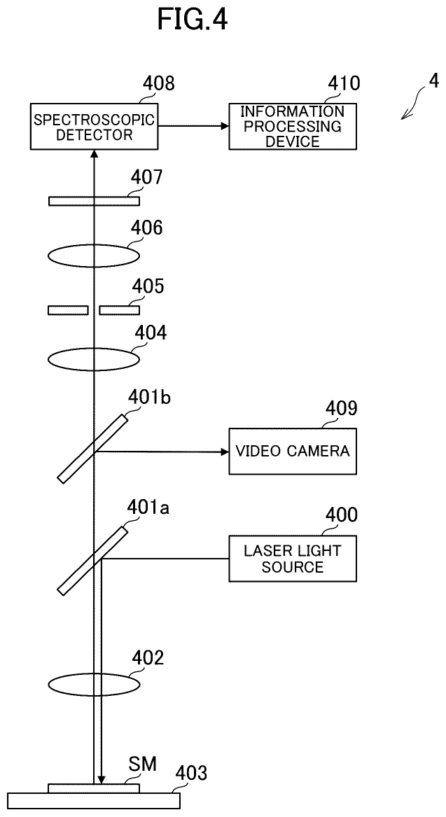

FIG. 4 is a diagram for illustrating an example of an overall configuration of a Raman microscope 4 in the first embodiment. The Raman microscope 4 includes a laser light source 400, beam splitters 401a and 401b, an objective lens 402, a stage 403, an imaging lens 404, a confocal pinhole 405, a collimating lens 406, an optical filter 407, a spectroscopic detector 408, a video camera 409, and an information processing device 410.

The laser light source 400 is a light source that generates laser light L1 as excitation light. The laser light L1 emitted from the laser light source 400 passes through the beam splitter 401a, and is condensed by the objective lens 402 on a sample SM placed on the stage 403.

When the laser light L1 is incident on the sample SM, outgoing light L2 including Raman scattered light is emitted from the sample SM. The outgoing light L2 is condensed by the imaging lens 404, and then passes through the confocal pinhole 405 to be collimated by the collimating lens 406. After that, the outgoing light L2 passes through the optical filter 407 to be guided to the spectroscopic detector 408. The optical filter 407 is a filter that removes Rayleigh scattered light from the outgoing light L2 and transmits only the Raman scattered light. The outgoing light L2 is branched off by the beam splitter 401b to be guided to the video camera 409. This video camera 409 is used for observing an image of the sample SM.

The spectroscopic detector 408 includes a spectroscope (not shown) and a detector (not shown). The spectroscope is a publicly-known spectroscope, for example, a Czerny-Turner type spectroscope. The detector is a publicly-known detector, for example, a CCD detector. The outgoing light L2 incident on the spectroscopic detector 408 is spectrally dispersed into light of respective wavelength components by the spectroscope, and the spectrally-dispersed light of the wavelength components enters the detector.

The information processing device 410 is, for example, a publicly-known computer system. The information processing device 410 includes a control unit, a storage unit, a display unit, and an input unit. The control unit includes at least one processor. The storage unit includes a main storage device such as a random access memory (RAM) and an auxiliary storage device capable of statically recording information, such as a hard disk drive (HDD) or a solid state drive (SSD). The storage unit stores a program in the first embodiment, and a physical property value calculation device 50 described later is embodied by the control unit executing this program. The storage unit also stores measured Raman spectrum data. The display unit is a display device that displays a Raman spectrum, a result of computation performed by the control unit, and the like. The input unit is a device for a user to input information, such as a keyboard, a mouse, or a touch panel.

A configuration of the Raman microscope 4 illustrated in FIG. 4 is merely an example, and the configuration of the Raman microscope 4 is not limited to this example. Further, in the first embodiment, the Raman microscope is described as an example of the Raman spectroscopic measurement device, but the Raman spectroscopic measurement device is not necessarily limited to the Raman microscope.

### 1-3. Functions Implemented in Physical Property Value Calculation Device According to First Embodiment

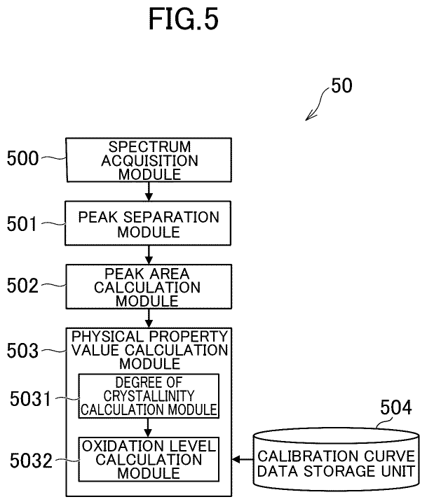

FIG. 5 is a functional block diagram for illustrating an example of functions implemented by the physical property value calculation device 50 according to the first embodiment. As illustrated in FIG. 5, the physical property value calculation device 50 includes a spectrum acquisition module 500, a peak separation module 501, a peak area calculation module 502, a physical property value calculation module 503, and a calibration curve data storage unit 504. The spectrum acquisition module 500, the peak separation module 501, the peak area calculation module 502, and the physical property value calculation module 503 are implemented mainly by the control unit of the information processing device 410. The calibration curve data storage unit 504 is mainly implemented by the storage unit of the information processing device 410.

The spectrum acquisition module 500 acquires the Raman spectrum S of the polyethylene to be measured. In the first embodiment, the spectrum acquisition module 500 acquires a Raman spectrum S measured by the Raman microscope 4. In the first embodiment, the Raman spectrum S having the baseline corrected in advance is assumed to be used, but the Raman spectrum S is not required to have the baseline corrected. Further, the spectrum acquisition module 500 may acquire the Raman spectrum S measured by another Raman spectroscopic measurement device.

As shown in FIG. 3, the Raman spectrum S has a superimposed peak in which a main peak (hereinafter sometimes referred to as “II1”), a first component (hereinafter sometimes referred to as “II2”), and a second component (hereinafter sometimes referred to as “II7”) overlap.

The main peak II1 is derived from the crystalline CH₂ twisting vibration. In this case, the crystalline CH₂ twisting vibration refers to twisting vibration of a CH₂ (methylene) group contained in a crystalline component in the polyethylene to be measured. In the Raman spectrum S of the polyethylene, the main peak II1 appears near 1,293 cm⁻¹. A wavenumber position at which the main peak II1 appears may vary from the above-mentioned value depending on conditions of the measurement device, the sample, and the like.

The first component II2 is positioned on a higher wavenumber side than the main peak II1, and is derived from the amorphous CH₂ twisting vibration. In this case, the amorphous CH₂ twisting vibration refers to twisting vibration of a CH₂ group contained in an amorphous component in the polyethylene to be measured. In the Raman spectrum S of the polyethylene, the first component II2 appears near 1, 305 cm⁻¹. A wavenumber position at which the first component II2 appears may vary from the above-mentioned value depending on conditions of the measurement device, the sample, and the like.

The second component II7 is positioned at a lower wavenumber side than the main peak II1. In the Raman spectrum S of polyethylene, the second component II7 appears near 1, 271 cm⁻¹. The inventors consider that the second component II7 may be a peak derived from a vibration mode of some functional group contained in the amorphous component in the polyethylene to be measured (that is, a peak derived from the amorphous component). A wavenumber position at which the second component II7 appears may vary from the above-mentioned value depending on conditions of the measurement device, the sample, and the like.

The peak separation module 501 applies a predetermined fitting function to each of the main peak II1, the first component 12, and the second component II7, to thereby separate the superimposed peak into an estimated main peak P1 corresponding to the main peak II1, an estimated first component P2 corresponding to the first component II2, and an estimated second component P7 corresponding to the second component II7, see FIG. 3. That is, the peak separation module 501 executes the peak fitting on each of the main peak II1, the first component II2, and the second component II7, to thereby separate the superimposed peak into the estimated main peak P1, the estimated first component P2, and the estimated second component P7.

In the first embodiment, a case in which the fitting function is a Gaussian function as indicated in Equation (2) below is described as an example. As indicated in Equation (2), the fitting function P(x) is expressed as a linear combination of Gaussian functions respectively corresponding to the seven peaks P1 to P7, see FIG. 1 and FIG. 3. In Equation (2) below, P(x) represents fitting function, “x” represents the wavenumber, Aᵢ represents the area of the peak Pi (i=1, 2, . . . 7), Wᵢ represents a width of the peak Pi, and X_{ci} represents a center wavenumber of the peak Pi. The fitting function is not limited to that indicated in Equation (2), and may be a Lorentz function, a Voigt function, or the like.

$$P ( x ) = {\sum }_{i = 1}^{7} \frac{{A}_{i} \sqrt{2 / π}}{{w}_{i} \cdot exp ( 2 {( x - {x}_{{c}_{i}} / {w}_{i} )}^{2} )} \qquad ( 2 )$$

As indicated in Equation (2), the fitting function P(x) includes the peak center wavenumber parameter X_{ci} and the peak width parameter wᵢ. The peak separation module 501 applies the fitting function P(x) to each of the main peak II1, the first component II2, and the second component II7 with the peak center wavenumber X_{ci} being used as a fixed parameter and the peak width Wᵢ being used as a variable parameter. The center wavenumber of each of the estimated main peak P1, the estimated first component P2, and the estimated second component P7 may be determined in advance, for example, based on previously-known data or by visual observation. Alternatively, the center wavenumber of each of the estimated main peak P1, the estimated first component P2, and the estimated second component P7 may be determined in advance through use of publicly-known spectrum analysis software. The peak separation module 501 applies the fitting function P(x), in which the center wavenumbers of the estimated main peak P1, the estimated first component P2, and the estimated second component P7 that have been determined in advance are substituted into X_{ci}, to the main peak II1, the first component II2, and the second component II7, respectively.

In this manner, the peak fitting is performed with the peak center wavenumber X_{ci} being used as a fixed parameter and the peak width wᵢ being used as a variable parameter, to thereby be able to easily separate the superimposed peak into the estimated main peak P1, the estimated first component P2, and the estimated second component P7.

The peak area calculation module 502 calculates each of the area of the estimated main peak P1, the area of the estimated first component P2, and the area of the estimated second component P7. In the first embodiment, the peak area calculation module 502 acquires parameters Aᵢ included in the fitting functions P(x) each regarding the estimated main peak P1, the estimated first component P2, and the estimated second component P7 as the area of the estimated main peak P1, the area of the estimated first component P2, and the area of the estimated second component P7, respectively.

The physical property value calculation module 503 calculates the physical property values of the polyethylene to be measured, based on the area of the estimated main peak P1, the area of the estimated first component P2, and the area of the estimated second component P7. In the first embodiment, the physical property values of the polyethylene calculated by the physical property value calculation module 503 are the degree of crystallinity and the oxidation level. That is, the physical property value calculation module 503 includes a degree of crystallinity calculation module 5031 and an oxidation level calculation module 5032.

The degree of crystallinity calculation module 5031 calculates the degree of crystallinity of the polyethylene to be measured, based on the area of the estimated main peak P1, the area of the estimated first component P2, and the area of the estimated second component P7. Specifically, the degree of crystallinity calculation module 5031 calculates the degree of crystallinity of the polyethylene to be measured, based on the area of the estimated main peak P1 and a sum of the area of the estimated first component P2 and the area of the estimated second component P7. More specifically, the degree of crystallinity calculation module 5031 calculates the degree of crystallinity of the polyethylene to be measured, based on Equation (3) below. In Equation (3) below, ∝ represents the degree of crystallinity of the polyethylene to be measured, Iₚ₁ represents the area of the estimated main peak P1, Iₚ₂ represents the area of the estimated first component P2, and Iₚ₇ represents the area of the estimated second component P7. The equation for calculating the degree of crystallinity is not limited to Equation (3), and any equation may be used for the degree of crystallinity.

$$α = \frac{{I}_{P 1}}{{I}_{P 2} + {I}_{P 7}} \qquad ( 3 )$$

The oxidation level calculation module 5032 calculates the oxidation level of the polyethylene to be measured, based on the calibration curve and the degree of crystallinity calculated by the degree of crystallinity calculation module 5031. The calibration curve indicates the relationship between the degree of crystallinity of the polyethylene and the oxidation level of the polyethylene. In the first embodiment, the oxidation level calculation module 5032 calculates the oxidation level of the polyethylene to be measured through use of the calibration curve stored in the calibration curve data storage unit 504. The oxidation level calculation module 5032 may calculate the oxidation level of the polyethylene to be measured through use of a calibration curve acquired from another device. For example, as disclosed in Japanese Patent No. 4384571 and Reference Document 1, the calibration curve may be created through use of an oxidation level calculated based on a ratio between an area of a peak (I₁₃₆₀) derived from vibration of a methylene group near 1, 360 cm⁻¹ and an area of a peak (I₁₇₂₀) derived from vibration of a carbonyl group near 1, 720 cm⁻¹ among peaks of an infrared spectrum of polyethylene measured by Fourier-transform infrared spectroscopy (FT-IR).

### 1-4. Processing Executed in Physical Property Value Calculation Device According to First Embodiment

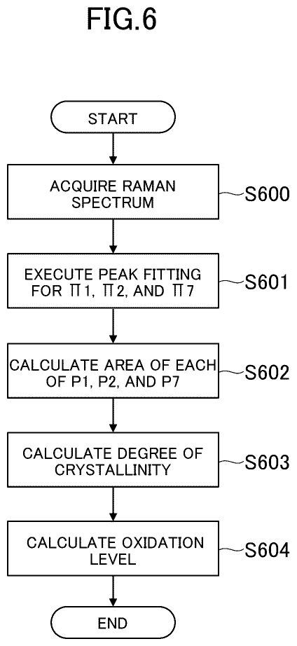

FIG. 6 is a flow chart for illustrating an example of processing executed in the physical property value calculation device 50 according to the first embodiment. The processing illustrated in FIG. 6 is executed by the control unit of the information processing device 410 operating in accordance with the program stored in the storage unit of the information processing device 410.

As illustrated in FIG. 6, the physical property value calculation device 50 first acquires a Raman spectrum of polyethylene including a superimposed peak (Step S600). Next, the physical property value calculation device 50 applies the fitting function P(x) to each of the main peak II1, the first component II2, and the second component II7, to thereby separate the superimposed peak into the estimated main peak P1, the estimated first component P2, and the estimated second component P7 (Step S601). The physical property value calculation device 50 calculates the area of each of the estimated main peak P1, the estimated first component P2, and the estimated second component P7 (Step S602). The physical property value calculation device 50 calculates the degree of crystallinity xx of the polyethylene to be measured, based on the area of the estimated main peak P1, the area of the estimated first component P2, and the area of the estimated second component P7 (Step S603). Finally, the physical property value calculation device 50 calculates the oxidation level of the polyethylene to be measured, based on the calibration curve indicating the relationship between the degree of crystallinity of the polyethylene and the oxidation level of the polyethylene and the calculated degree of crystallinity x (Step S604), and this process ends.

### 2. Second Embodiment

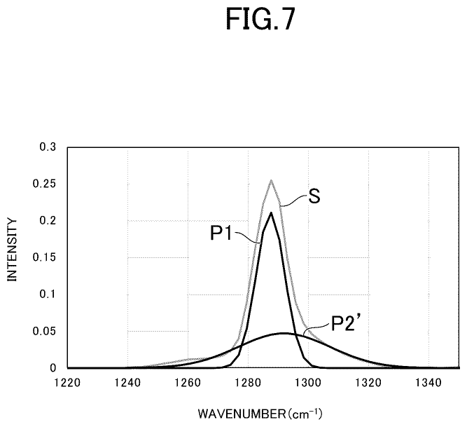

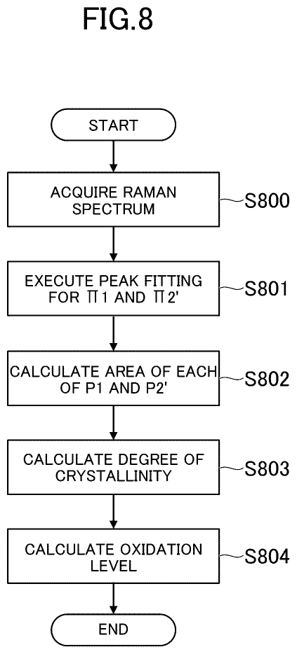

Next, a second embodiment of the present invention is described with reference to FIG. 7 and FIG. 8. A configuration and components in the second embodiment are the same as the configuration and components in the first embodiment except for parts specifically mentioned below.

### 2-1. Overview of Second Embodiment

In the first embodiment, the fitting function is applied to each of the main peak II1, the first component II2, and the second component II7, to thereby separate the superimposed peak into the estimated main peak P1, the estimated first component P2, and the estimated second component P7. Then, the degree of crystallinity and the oxidation level of the polyethylene to be measured are calculated based on the area of the estimated main peak P1, the area of the estimated first component P2, and the area of the estimated second component P7.

Meanwhile, in the second embodiment, as shown in FIG. 7, the fitting function is applied to each of the main peak II1 and a sub-peak II2′, to thereby separate the superimposed peak into the estimated main peak P1 and an estimated sub-peak P2′. In this case, the sub-peak II2′ is a peak that includes the first component II2 and the second component II7. Then, the degree of crystallinity and the oxidation level of the polyethylene to be measured are calculated based on the area of the estimated main peak P1 and the area of the estimated sub-peak P2′.

In this manner, in the second embodiment, there are only two peaks to which the fitting function is to be applied, and hence the degree of crystallinity and the oxidation level can be calculated more simply than in the first embodiment in which there are three peaks to which the fitting function is to be applied. In addition, one of the two peaks to which the fitting function is to be applied, specifically, II2′ includes not only the first component II2 but also the second component II7, and hence accuracy of the calculated degree of crystallinity and oxidation level is also guaranteed. Details of the second embodiment are described below.

### 2-2. Functions Implemented in Physical Property Value Calculation Device According to Second Embodiment

In the same manner as the physical property value calculation device 50 according to the first embodiment illustrated in FIG. 5, the physical property value calculation device 50 according to the second embodiment includes the spectrum acquisition module 500, the peak separation module 501, the peak area calculation module 502, the physical property value calculation module 503, and the calibration curve data storage unit 504. The physical property value calculation module 503 includes the degree of crystallinity calculation module 5031 and the oxidation level calculation module 5032.

The peak separation module 501 in the second embodiment applies a predetermined fitting function to each of the main peak II1 and the sub-peak II2′, to thereby separate the superimposed peak into the estimated main peak P1 corresponding to the main peak Ill and the estimated sub-peak P2′ corresponding to the sub-peak II2′, see FIG. 7. As described above, the sub-peak II2′ includes the first component II2 and the second component II7.

In the second embodiment, a case in which the fitting function is a Gaussian function as indicated in Equation (4) below is described as an example. As indicated in Equation (4), the fitting function P(x) is expressed as a linear combination of Gaussian functions respectively corresponding to the six peaks P1 to P6, see FIG. 1 and FIG. 7. In Equation (4) below, P (x) represents the fitting function, “x” represents the wavenumber, Aᵢ represents the area of the peak Pi (i=1, 2′, . . . 6), Wᵢ represents a width of the peak Pi, and X_{ci} represents a center wavenumber of the peak Pi. The fitting function is not limited to that indicated in Equation (4), and may be a Lorentz function, a Voigt function, or the like.

$$P ( x ) = {\sum }_{i = 1}^{6} \frac{{A}_{i} \sqrt{2 / π}}{{w}_{i} \cdot exp ( 2 {( x - {x}_{{c}_{i}} / {w}_{i} )}^{2} )} \qquad ( 4 )$$

The peak separation module 501 in the second embodiment applies the fitting function P(x) to each of the main peak II1 and the sub-peak 12′ with the peak center wavenumber X_{ci} and the peak width wᵢ being used as variable parameters. That is, in the second embodiment, unlike in the first embodiment, the center wavenumber of each of the main peak II1 and the sub-peak II2′ is not determined in advance, and is calculated by the peak fitting.

In this manner, the peak fitting is performed with the peak center wavenumber X_{ci} and the peak width Wᵢ being used as variable parameters, to thereby be able to easily extract the sub-peak II2′ including the first component II2 and the second component II7.

The peak area calculation module 502 in the second embodiment calculates each of the area of the estimated main peak P1 and the area of the estimated sub-peak P2′. In the second embodiment, the peak area calculation module 502 acquires parameters Aᵢ included in the fitting functions P(x) each regarding the estimated main peak P1 and the estimated sub-peak P2′ as the area of the estimated main peak P1 and the area of the estimated sub-peak P2′, respectively.

The physical property value calculation module 503 in the second embodiment calculates the physical property values (degree of crystallinity and oxidation level) of the polyethylene to be measured, based on the area of the estimated main peak P1 and the area of the estimated sub-peak P2′.

The degree of crystallinity calculation module 5031 in the second embodiment calculates the degree of crystallinity of the polyethylene to be measured, based on the area of the estimated main peak P1 and the area of the estimated sub-peak P2′. Specifically, the degree of crystallinity calculation module 5031 in the second embodiment calculates the degree of crystallinity of the polyethylene to be measured, based on the ratio of the area of the estimated main peak P1 to the area of the estimated sub-peak P2′. More specifically, the degree of crystallinity calculation module 5031 in the second embodiment calculates the degree of crystallinity of the polyethylene to be measured, based on Equation (5) below. In Equation (5) below, ∝ represents the degree of crystallinity of the polyethylene to be measured, Iₚ₁ represents the area of the estimated main peak P1, and Iₚ₂′ represents the area of the estimated sub-peak P2′. The equation for calculating the degree of crystallinity is not limited to Equation (5), and any equation may be used for the degree of crystallinity.

$$α = \frac{{I}_{P 1}}{{I}_{P {2}^{′}}} \qquad ( 5 )$$

### 2-3. Processing Executed in Physical Property Value Calculation Device According to Second Embodiment

FIG. 8 is a flow chart for illustrating an example of processing executed in the physical property value calculation device 50 according to the second embodiment. The processing illustrated in FIG. 8 is executed by the control unit of the information processing device 410 operating in accordance with the program stored in the storage unit of the information processing device 410.

As illustrated in FIG. 8, the physical property value calculation device 50 first acquires a Raman spectrum of polyethylene including a superimposed peak (Step S800). Next, the physical property value calculation device 50 applies the fitting function P(x) to each of the main peak II1 and the sub-peak II2′, to thereby separate the superimposed peak into the estimated main peak P1 and the estimated sub-peak P2′ (Step S801). The physical property value calculation device 50 calculates the area of each of the estimated main peak P1 and the estimated sub-peak P2′ (Step S802). The physical property value calculation device 50 calculates the degree of crystallinity ∝ of the polyethylene to be measured, based on the area of the estimated main peak P1 and the area of the estimated sub-peak P2′ (Step S803). Finally, the physical property value calculation device 50 calculates the oxidation level of the polyethylene to be measured, based on the calibration curve indicating the relationship between the degree of crystallinity of the polyethylene and the oxidation level of the polyethylene and the calculated degree of crystallinity x (Step S804), and this process ends.

### 3. Conclusion

According to the first embodiment and the second embodiment described above, when the physical property values of the polymer material are to be calculated, it is not required to use P4 that is liable to be influenced by the slope of the baseline, and hence it is possible to easily calculate accurate physical property values even when a slope appears in the baseline.

### 4. Modification Example

It should be noted that the present invention is not limited to the above-mentioned embodiments. Further, the specific character strings and numerical values described above and the specific character strings and numerical values in the drawings are merely exemplary, and the present invention is not limited to those character strings and numerical values.

For example, the polymer material targeted by the physical property value calculation method, the physical property value calculation device, and the program according to the present invention is not limited to the polyethylene that is used for an artificial joint, and may be general-purpose polyethylene. Further, the physical property value calculation method, the physical property value calculation device, and the program according to at least one embodiment of the present invention may target various polymer materials having a CH₂ group, such as polystyrene, polypropylene, and polyvinyl chloride, in addition to polyethylene.

Further, the physical property value to be calculated by the physical property value calculation method, the physical property value calculation device, and the program according to the present invention is not limited to the oxidation level. In the physical property value calculation method, the physical property value calculation device, and the program according to the present invention, various physical property values, such as strain and stress, corresponding to the degree of crystallinity of the polymer material may be calculated.

Further, in the first embodiment, the physical property values of the polyethylene to be measured are calculated based on the area of the estimated main peak P1, the area of the estimated first component P2, and the area of the estimated second component P7. However, the physical property values of the polyethylene to be measured may be calculated based on, for example, the width of the estimated main peak P1, the width of the estimated first component P2, and the width of the estimated second component P7. In another case, the physical property values of the polyethylene to be measured may be calculated based on the height of the estimated main peak P1, the height of the estimated first component P2, and the height of the estimated second component P7.

In short, in the physical property value calculation method, the physical property value calculation device, and the program according to the present invention, it suffices that a main intensity index value corresponding to an intensity of the estimated main peak P1, a first intensity index value corresponding to an intensity of the estimated first component P2, and a second intensity index value corresponding to an intensity of the estimated second component P7 are calculated and the physical property values of the polymer material are calculated based on the main intensity index value, the first intensity index value, and the second intensity index value.

In the second embodiment, in the same manner, the physical property values of the polyethylene to be measured may be calculated based on the width of the estimated main peak P1 and the width of the estimated sub-peak P2′. In another case, the physical property values of the polyethylene to be measured may be calculated based on the height of the estimated main peak P1 and the height of the estimated sub-peak P2′.

In short, in the physical property value calculation method, the physical property value calculation device, and the program according to at least one embodiment of the present invention, it suffices that a main intensity index value corresponding to an intensity of the estimated main peak P1 and a sub-intensity index value corresponding to an intensity of the estimated sub-peak P2′ are calculated and the physical property values of the polymer material are calculated based on the main intensity index value and the sub-intensity index value.

Further, in each of the first embodiment and the second embodiment, the case in which the peak fitting is performed through use of one fitting function expressed as a linear combination of Gaussian functions respectively corresponding to the seven or six peaks has been described as an example, but a plurality of Gaussian functions corresponding to individual peaks may be used as fitting functions. Further, in each of the first embodiment and the second embodiment, the case in which peak fitting is performed for the peaks (P3 to P6) other than P1, P2, and P7 (or P1 and P2′) has been described, but it is not required to perform the peak fitting for those peaks P3 to P6. That is, it suffices that the peak fitting is performed for at least P1, P2, and P7 (or P1 and P2′).

Further, in the first embodiment, Equation (2) is used as the fitting function, but Equation (6) below may be used as the fitting function. In Equation (6) below, P(x) represents the fitting function, “x” represents the wavenumber, Hᵢ represents the height of the peak Pi (i=1, 2, . . . 7), Wᵢ represents the width of the peak Pi, and X_{ci} represents the center wavenumber of the peak Pi. Unlike Equation (2), Equation (6) does not have the peak area as a parameter, but instead has a peak height as a parameter. In regard to the second embodiment as well, the same equation may be used as the fitting function.

$$P ( x ) = {\sum }_{i = 1}^{7} \frac{{H}_{i}}{exp ( 2 {( x - {x}_{{c}_{i}} / {w}_{i} )}^{2} )} \qquad ( 6 )$$

When Equation (6) above is used as the fitting function, the peak area calculation module 502 may calculate the area of the estimated main peak P1, the area of the estimated first component P2, and the area of the estimated second component P7 by integrating the Gaussian function corresponding to the estimated main peak P1, the Gaussian function corresponding to the estimated first component P2, and the Gaussian function corresponding to the estimated second component P7, which are respectively included in the fitting function P(x). More specifically, the peak area calculation module 502 may calculate the area of the estimated main peak P1, the area of the estimated first component P2, and the area of the estimated second component P7 based on Equation (7) below. In Equation (7) below, Iᵢ represents the area of the peak Pi (i=1, 2, and 7). In regard to the second embodiment as well, each peak area may be calculated in the same manner.

$${I}_{i} = {\int }_{- ∞}^{∞} \frac{{H}_{i}}{exp ( 2 {( x - {x}_{{C}_{i}} / {w}_{i} )}^{2} )} dx \qquad ( 7 )$$

Further, in the first embodiment, the degree of crystallinity calculation module 5031 calculates the degree of crystallinity of the polyethylene to be measured, based on the area of the estimated main peak P1 and the sum of the area of the estimated first component P2 and the area of the estimated second component P7, but the degree of crystallinity calculation module 5031 may calculate the degree of crystallinity of the polyethylene to be measured, based on the area of the estimated main peak P1 and a sum of the area of the estimated main peak P1, the area of the estimated first component P2, and the area of the estimated second component P7. More specifically, the degree of crystallinity calculation module 5031 may calculate the degree of crystallinity of the polyethylene to be measured, based on Equation (8) below. In the same manner, in regard to the second embodiment as well, the degree of crystallinity of the polyethylene to be measured may be calculated based on the area of the estimated main peak P1 and a sum of the area of the estimated main peak P1 and the area of the estimated sub-peak P2′.

$$α = \frac{{I}_{P 1}}{{I}_{P 1} + {I}_{P 2} + {I}_{P 7}} \qquad ( 8 )$$

While there have been described what are at present considered to be certain embodiments of the invention, it will be understood that various modifications may be made thereto, and it is intended that the appended claims cover all such modifications as fall within the true spirit and scope of the invention.

What is claimed is:

1. A physical property value calculation method for a polymer material, comprising:
a spectrum acquisition step of acquiring a Raman spectrum of a polymer material, the Raman spectrum having a superimposed peak in which a main peak and a sub-peak overlap, wherein the main peak is derived from crystalline CH₂ twisting vibration, includes a first component positioned at a and the sub-peak higher wavenumber side than the main peak and derived from amorphous CH₂ twisting vibration, and a second component positioned at a lower wavenumber side than the main peak;
a peak separation step of separating the superimposed peak into an estimated main peak corresponding to the main peak and an estimated sub-peak corresponding to the sub-peak, by applying a predetermined fitting function to each of the main peak and the sub-peak;
a peak intensity index value calculation step of calculating a main intensity index value indicating an intensity of the estimated main peak and a sub-intensity index value indicating an intensity of the estimated sub-peak; and
a physical property value calculation step of calculating a physical property value of the polymer material based on the main intensity index value and the sub-intensity index value.

2. The physical property value calculation method for a polymer material according to claim 1,
wherein the peak separation step includes further separating the sub-peak into an estimated first component corresponding to the first component and an estimated second component corresponding to the second component, by applying the predetermined fitting function to each of the first component and the second component,
wherein the peak intensity index value calculation step includes calculating, as the sub-intensity index value, a first intensity index value indicating an intensity of the estimated first component and a second intensity index value indicating an intensity of the estimated second component, and
wherein the physical property value calculation step includes calculating the physical property value of the polymer material based on the main intensity index value, the first intensity index value, and the second intensity index value.

3. The physical property value calculation method for a polymer material according to claim 2,
wherein the predetermined fitting function includes a peak center wavenumber parameter and a peak width parameter, and
wherein the peak separation step includes applying the predetermined fitting function to each of the main peak, the first component, and the second component with the peak center wavenumber being used as a fixed parameter and the peak width being used as a variable parameter.

4. The physical property value calculation method for a polymer material according to claim 2, wherein the physical property value calculation step includes calculating the physical property value of the polymer material based on a ratio between the main intensity index value and a sum of the first intensity index value and the second intensity index value.

5. The physical property value calculation method for a polymer material according to claim 2,
wherein the main intensity index value comprises an area of the estimated main peak,
wherein the first intensity index value comprises an area of the estimated first component, and
wherein the second intensity index value comprises an area of the estimated second component.

6. The physical property value calculation method for a polymer material according to claim 1,
wherein the predetermined fitting function includes a peak center wavenumber parameter and a peak width parameter, and
wherein the peak separation step includes applying the predetermined fitting function to the main peak and to the sub-peak, with the peak center wavenumber and the peak width being used as variable parameters.

7. The physical property value calculation method for a polymer material according to claim 6, wherein the physical property value calculation step includes calculating the physical property value of the polymer material based on a ratio between the main intensity index value and the sub-intensity index value.

8. The physical property value calculation method for a polymer material according to claim 6,
wherein the main intensity index value comprises an area of the estimated main peak, and
wherein the sub-intensity index value comprises an area of the estimated sub-peak.

9. The physical property value calculation method for a polymer material according to claim 1, wherein the physical property value comprises a physical property value corresponding to a degree of crystallinity of the polymer material.

10. The physical property value calculation method for a polymer material according to claim 1, wherein the physical property value comprises an oxidation level of the polymer material.

11. A physical property value calculation device for a polymer material, comprising at least one processor configured to:
acquire a Raman spectrum of a polymer material, the Raman spectrum having a superimposed peak in which a main peak and a sub-peak overlap, wherein the main peak is derived from crystalline CH₂ twisting vibration, and the sub-peak includes a first component positioned at a higher wavenumber side than the main peak and derived from amorphous CH₂ twisting vibration and a second component positioned at a lower wavenumber side than the main peak;
separate the superimposed peak into an estimated main peak corresponding to the main peak and an estimated sub-peak corresponding to the sub-peak, by applying a predetermined fitting function to each of the main peak and the sub-peak;
calculate a main intensity index value indicating an intensity of the estimated main peak and a sub-intensity index value indicating an intensity of the estimated sub-peak; and
calculate a physical property value of the polymer material based on the main intensity index value and the sub-intensity index value.

12. A non-transitory computer-readable information storage medium having stored thereon a program for causing a computer to:
acquire a Raman spectrum of a polymer material, the Raman spectrum having a superimposed peak in which a main peak and a sub-peak overlap, wherein the main peak is derived from crystalline CH₂ twisting vibration, and the sub-peak includes a first component positioned at a higher wavenumber side than the main peak and derived from amorphous CH₂ twisting vibration, and a second component positioned at a lower wavenumber side than the main peak;
separate the superimposed peak into an estimated main peak corresponding to the main peak and an estimated sub-peak corresponding to the sub-peak, by applying a predetermined fitting function to each of the main peak and the sub-peak;
calculate a main intensity index value indicating an intensity of the estimated main peak and a sub-intensity index value indicating an intensity of the estimated sub-peak; and
calculate a physical property value of the polymer material based on the main intensity index value and the sub-intensity index value.
